(19) United States
(12) Patent Application Publication
(10) Pub. No.: US 2008/0071013 A1
(43) Pub. Date: Mar. 20, 2008

(54) Novel thermoplastic pelletizing technology

(76) Inventors: David Abecassis, Huntington, NY (US); Mayu Si, Hudson, OH (US); Edward Wiegel, Baltimore, MD (US)

Correspondence Address: Thomas A. O'Rourke, Bodner & O'Rourke, 425 Broadhollow Road, Melville, NY, 11747, US

(21) Appl. No.: 11/827,661

(22) Filed: Jul. 12, 2007

Related U.S. Application Data
(60) Provisional application No. 60/830,164, filed on Jul. 12, 2006.

(51) Int. Cl. C08K 5/53; C08K 3/34

(52) U.S. Cl. 524/132; 524/445; 524/447

(57) ABSTRACT

Diphosphate such as resorcinol diphosphate or bis-phenol diphosphate act as an agglomerating agent or binder for quaternary amine treated organoclays. The blends so formed may be used as an additive in thermoplastics to form thermoplastic nanocomposites. More elastomeric materials may be added to the blend to improve the physical properties of the blend

This application claims priority on U.S. application Ser. No. 60/830,164 filed Jul. 12, 2006, the disclosures of which are incorporated herein by reference.

### FIELD OF THE INVENTION

The present invention is directed towards improved additives for use with thermoplastic materials. The additives have particular application in the formation of nanocomposite plastics.

### BACKGROUND OF THE INVENTION

Additives for thermoplastics have been widely used to impart a wide variety of properties in thermoplastic polymers. Organoclays, in particular those associated with quaternary amine organic treatment have two significant processing disadvantages;
1. They produce significant amounts of undesirable dust during processing and handling.
2. They tend to flow like a fluid and thus are difficult to meter along with the pelletized thermoplastic resin beads; which are distinct and particulate in nature and thus feed well with existing plastics processing equipment.

Organoclays form nano-structured materials with plastics by self-distributing and separating out into individual crystals in the plastic polymer matrix. This microstructure gives the nano-modified plastics new properties such as barrier, UV resistance, ease of processing as well as mechanical resistance to deformation far beyond the value achievable with the virgin unmodified plastic. The transformational effects of quaternary treated organoclays on thermoplastics is far beyond the loading rate value of the additive. So unlike normal plastics additives which add linear increases in properties based upon loading rates, quaternary amine treated organoclays have effects which normally require much higher loading rates for the achievement of a given UV, barrier or mechanical property if a conventional additive is used. It is for this reason that having the quaternary amine treated organoclay which is pelletized and easily metered is important to the successful use of these organoclays in conventional plastics processing.

Uneven feeding of quaternary amine treated organoclays into a melt blend polymer thus produces differences in properties per linear extruded foot of thermoplastic, and anisotropic properties in the resulting material. The normal solution to this problem is to re-feed the plastic pellets into the melt blend processing in order to average out the clay distribution. This adds downtime and additional processing cost to the nanocomposite plastic manufacturing process. Resolving theses two inherent disadvantage to quaternary amine treated clay use is a significant boost to their effective use in the thermoplastics industry.

### OBJECTS OF THE INVENTION

It is an object of the invention to provide an agglomeration/pelletizing technology for quaternary amine treated organoclays.

It is also an object of the invention to reduce dust generation during the use of quaternary amine treated organoclay

It is also an object of the invention to allow for the granulation of quaternary treated organoclay to allow for uniform metering during melt processing.

It is an additional object of the invention to simultaneously add processing/impact modifiers during the organoclay addition to the melt blend thermoplastic.

### SUMMARY OF THE INVENTION

The present invention is directed towards blends diphosphates such as resorcinol diphosphate or bis-phenol diphosphate as an agglomerating/pelletizing agent for quaternary amine treated organoclays. These blends can be used for the manufacture of nanocomposite plastics. In the process of the present invention, a diphosphate or blends of two or more diphosphates are mixed with one or more organoclays or blends thereof. The preferred diphosphates are resorcinol diphosphate (RDP) and bis-phenol diphosphate (BDP). In a preferred embodiment the agglomerating/pelletizing agent is a mixture of the two aforementioned diphosphate organics (RDP) and/or (BDP) are mixed with the organoclays. Preferred clays are quaternary amine treated Wyoming varieties of swelling bentonite and similar clays, and hectorites which is a swelling magnesium lithium clay, as well as synthetically prepared smectite-type clays, such as montmorrillonite, bentonite, beidelite, hectoritesaponite, and stevensite.

The diphosphate is blended with the organoclay and formed into a pellets which are then mixed with the thermoplastic material in for example a hopper in an extruder. In addition to the RDP and/or BDP treatment that is applied to the clay, other materials can be used in the mixture with the organoclay and diphosphate. These materials can include one or more polyethylene waxes as well as a fumed silica. The polyethylene wax and/or fumed silica can be added to the pellet as additional processing aids for the thermoplastic material that is being blended with the organoclay diphosphate mixture. The polyethylene wax and fumed silica are added because they serve respectively as impact agents and to eliminate any gumminess added into the pellet by the diphosphate. The fumed silica has particular applicability when the diphosphate is an RDP and/or BDP binding agent in the blend with the organoclay.

### DETAILED DESCRIPTION OF THE INVENTION

The diphosphate and organoclay are mixed together using conventional mixing equipment. The blend of the diphosphate and organoclay is then processed into pellets using conventional pelletizers commonly used in materials processing. If desired, other materials can be used in the mixture with the organoclay and diphosphate. These materials can include one or more polyethylene waxes as well as a fumed silica.

For example, 1 part by weight of a quaternary amine treated organoclay may receive and be mixed with 0.1 to 0.5 parts by weight of RDP and/or BDP. If desired, an additional 0.1 to 0.5 parts by weight polyethylene wax or low molecular weight polyethylene used for impact modification, and/or 0.1 part to 0.5 parts by weight fumed silica can be added to the blend of diphosphate and organoclay.

After the materials have been blended the mixture is then compressed into pellets for use with a thermoplastic material. These pellets can be used as thermoplastic nanocomposite forming thermoplastic additives.

The RDP and/or BDP can be added to the organoclay either cold, or pre-heated up to about 100 degrees Celsius. Heating the diphosphate material reduce the viscosity of the disphosphate as it is being blended with the organoclay. A higher viscosity provides for more uniform blending of the materials. Alternatively, the blender can be heated so that the organoclay and the diphosphate as well as any other materials added to the blend can be heated. The solids i.e., the polyethylene wax and or the fumed silica can be premixed with the quaternary amine treated clays prior to adding the RDP and/or BDP. During blending, the material thickens into a dry solid paste which then can hold it's shape after the blend is subjected to pelletizing. In a preferred embodiment, the pellets can then be coated en masse with additional dry quaternary amine treated organoclay to reduce stickiness of each individual pellet. The pellets thus formed are then ready for direct use as a hopper-fed thermoplastic additives into quaternary amine treated thermoplastics.

In a preferred embodiment RDP and or BDP acts as an agglomerating agent/binder for quaternary amine treated organoclays in preferred loading rates from 10% by weight RDP and or BDP with the remainder quaternary amine treated clay to 50% by weight RDP and/or BDP with the remainder quaternary amine treated clay. In another preferred embodiment 10%-50% by weight low molecular weight polyethylene impact modifier can be added to the diphosphate and quaternary amine treated clay blend. In alternative embodiment 1%-0.20% by weight fumed silica can be added to the blend of diphosphate and quaternary amine treated clay blend. These additives are preferably added to the dry mix prior to pelletizing. The blend of the present invention is subjected to pelletizing in a hopper or in extrusion equipment and then cut into pellets for use as a thermoplastic additive and mixed with the pellets of the thermoplastic material.

The low molecular weight polyethylene can be a high pressure branched low density polyethylene or LDPE or a low pressure or linear polyethylene. The preferred low pressure or linear polyethylene can be a linear low density polyethylene or LLDPE and/or ultra linear low density polyethylene or ULLDPE. The density of the low molecular weight polyethylene useful in the present invention is preferably between about 0.910-0.925 g/cm³. Linear LDPEs (LLDPEs) are typically obtained by incorporating sufficient .alpha.-olefin comonomers into linear polyethylene to produce polyethylene with a density between about 0.910-0.925 g/cm.³. The alpha.-olefin comonomers are essentially excluded from the crystal lattice of polyethylene; therefore, their presence serves to disrupt the crystallizability of the linear chain, which can lead to polyethylenes having lower densities (crystallinity). By definition, LLDPEs comprise essentially no (e.g., less than about 0.1% by weight of the polyethylene) long branches (e.g., branches longer than the critical entanglement molecular weight of polyethylene). These polymers can be produced in low pressure gas phase fluidized bed reactors, solution process reactors or in slurry loop reactors. Ultra linear low density polyethylenes, ULLDPEs, which incorporate even higher levels of .alpha.-olefin comonomers into linear polyethylene have densities lower than about 0.910 g/cm.³ and can be produced in reactors similar to those used to produce LLDPEs. Ultra low density polymers can also be added to the blend as well.

We claim:

1. A method of forming a nanocomposite thermoplastic blend comprising mixing a one or more diphosphates with one or more organoclays and coating said organoclays with said diphosphate and adding the mixture so formed to a thermoplastic material.

2. The method according to claim 1 wherein at least one of said diphosphates is resorcinol diphosphate.

3. The method according to claim 1 wherein at least one of said diphosphates is bis-phenol diphosphate.

4. The method according to claim 2 wherein said organoclay is a quaternary amine treated clay.

5. The method according to claim 4 wherein the clay is selected from the group consisting of bentonite, hectorite and smectite-type clays.

6. The method according to claim 5 wherein the smectite-type clays consist essentially of montmorrillonite, beidelite, hectoritesaponite, and stevensite.

7. The method according to claim 4 further comprises forming said blend of diphosphate and organoclay into a pellet and mixing the blend with a thermoplastic pellet.

8. The method according to claim 7 wherein said pellet further comprises a polyethylene wax.

9. The method according to claim 7 wherein said pellet further comprises fumed silica.

10. The method according to claim 7 wherein for each part by weight of a quaternary amine treated organoclay present in the blend there is 0.1 to 0.5 parts by weight diphosphate.

11. The method according to claim 10 wherein for each part by weight of a quaternary amine treated organoclay present in the blend there is 0.1 to 0.5 parts by weight polyethylene wax.

12. The method according to claim 10 wherein for each part by weight of a quaternary amine treated organoclay present in the blend there is 0.1 to 0.5 parts by weight low molecular weight polyethylene

13. The method according to claim 10 wherein for each part by weight of a quaternary amine treated organoclay present in the blend there is 0.1 to 0.5 parts by weight fumed silica.

14. The method according to claim 3 wherein said organoclay is a quaternary amine treated clay.

15. The method according to claim 14 wherein the clay is selected from the group consisting of bentonite, hectorite and smectite-type clays.

16. The method according to claim 15 wherein the smectite-type clays consist essentially of montmorrillonite, beidelite, hectoritesaponite, and stevensite.

17. The method according to claim 14 further comprises forming said blend of diphosphate and organoclay into a pellet and mixing the blend with a thermoplastic pellet.

18. The method according to claim 17 wherein said pellet further comprises a polyethylene wax.

19. The method according to claim 17 wherein said pellet further comprises fumed silica.

20. The method according to claim 17 wherein for each part by weight of a quaternary amine treated organoclay present in the blend there is 0.1 to 0.5 parts by weight diphosphate.

21. The method according to claim 20 wherein for each part by weight of a quaternary amine treated organoclay present in the blend there is 0.1 to 0.5 parts by weight polyethylene wax.

22. The method according to claim 20 wherein for each part by weight of a quaternary amine treated organoclay present in the blend there is 0.1 to 0.5 parts by weight low molecular weight polyethylene

23. The method according to claim 20 wherein for each part by weight of a quaternary amine treated organoclay present in the blend there is 0.1 to 0.5 parts by weight fumed silica.

24. A thermoplastic nanocomposite comprising one or more diphosphates blended with one or more organoclays and mixing said blend with a thermoplastic material to form a nanocomposite.

25. The nanocomposite according to claim 24 wherein at least one of said diphosphates is resorcinol diphosphate.

26. The nanocomposite according to claim 24 wherein at least one of said diphosphates is bis-phenol diphosphate.

27. The nanocomposite according to claim 25 wherein said organoclay is a quaternary amine treated clay.

28. The nanocomposite according to claim 27 wherein the clay is selected from the group consisting of bentonite, hectorite and smectite-type clays.

29. The nanocomposite according to claim 28 wherein the smectite-type clays consist essentially of montmorrillonite, beidelite, hectoritesaponite, and stevensite.

30. The nanocomposite according to claim 27 further comprises forming said blend of diphosphate and organoclay into a pellet and mixing the blend with a thermoplastic pellet.

31. The nanocomposite according to claim 30 wherein said pellet further comprises a polyethylene wax.

32. The nanocomposite according to claim 30 wherein said pellet further comprises fumed silica.

33. The nanocomposite according to claim 30 wherein for each part by weight of a quaternary amine treated organoclay present in the blend there is 0.1 to 0.5 parts by weight diphosphate.

34. The nanocomposite according to claim 33 wherein for each part by weight of a quaternary amine treated organoclay present in the blend there is 0.1 to 0.5 parts by weight polyethylene wax.

35. The nanocomposite according to claim 33 wherein for each part by weight of a quaternary amine treated organoclay present in the blend there is 0.1 to 0.5 parts by weight low molecular weight polyethylene

36. The nanocomposite according to claim 33 wherein for each part by weight of a quaternary amine treated organoclay present in the blend there is 0.1 to 0.5 parts by weight fumed silica.

37. The nanocomposite according to claim 26 wherein said organoclay is a quaternary amine treated clay.

38. The nanocomposite according to claim 37 wherein the clay is selected from the group consisting of bentonite, hectorite and smectite-type clays.

39. The nanocomposite according to claim 38 wherein the smectite-type clays consist essentially of montmorrillonite, beidelite, hectoritesaponite, and stevensite.

40. The nanocomposite according to claim 37 further comprises forming said blend of diphosphate and organoclay into a pellet and mixing the blend with a thermoplastic pellet.

41. The nanocomposite according to claim 40 wherein said pellet further comprises a polyethylene wax.

42. The nanocomposite according to claim 40 wherein said pellet further comprises fumed silica.

43. The nanocomposite according to claim 40 wherein for each part by weight of a quaternary amine treated organoclay present in the blend there is 0.1 to 0.5 parts by weight diphosphate.

44. The nanocomposite according to claim 43 wherein for each part by weight of a quaternary amine treated organoclay present in the blend there is 0.1 to 0.5 parts by weight polyethylene wax.

45. The nanocomposite according to claim 43 wherein for each part by weight of a quaternary amine treated organoclay present in the blend there is 0.1 to 0.5 parts by weight low molecular weight polyethylene

46. The nanocomposite according to claim 43 wherein for each part by weight of a quaternary amine treated organoclay present in the blend there is 0.1 to 0.5 parts by weight fumed silica.
